(19) United States
(12) Patent Application Publication
(10) Pub. No.: US 2022/0245010 A1
(43) Pub. Date: Aug. 4, 2022

(54) TIME-SERIES ANOMALY DETECTION USING AN INVERTED INDEX

(71) Applicant: GOOGLE LLC, Mountain View, CA (US)

(72) Inventors: Emanuel Taropa, Los Altos, CA (US); Dragos Dena, San Francisco, CA (US)

(21) Appl. No.: 17/596,155

(22) PCT Filed: Sep. 23, 2019
(86) PCT No.: PCT/US2019/052437

§ 371 Date: Dec. 3, 2021

(51) Int. Cl. G06F 11/00; G06F 11/34; G06F 11/30

(52) U.S. Cl. CPC G06F 11/006; G06F 2201/86; G06F 11/3034; G06F 11/3452

(57) ABSTRACT

Implementations identify anomalous events from indexed events. An example system receives s dimension(s) for events, a test start time and a test duration defining a test interval. The system may identify a set of events matching the dimension(s). The set includes events occurring within a test interval or within one of at least two reference intervals. The system generates, for the test interval and the reference intervals, an aggregate value for each unique combination of dimension values in the set of events. The system selects at least one of the unique combination of dimension values for anomaly detection based on a comparison of the aggregate values for the reference intervals and the test interval, and performs anomaly detection on a historical time series for the selected unique combination of dimension values. The system may report any of the selected unique combination of dimension values identified as an anomaly.

### BACKGROUND

Many different problems benefit from anomaly and trend detection, from production monitoring, banking transactions, medical transactions, to breaking or trending news identification. Such detection systems operate over time-series data, e.g., tracking some value for an event with a particular dimension label or combination of dimension labels over time period. Some anomaly/trend detection systems may use a forecasting model to determine whether a value falls outside of a predicted range. But forecasting models are highly dependent upon the dimensions modeled and are computationally intensive to train. Therefore such systems operate on a pre-trained model with specific dimensions or run as a batch job.

### SUMMARY

An anomaly or trend detection system, or for brevity, a detection system, is a distributed computer system that identifies anomalies or trends based on large-scale aggregations of time-series data. The detection system is flexible and efficient, enabling identification of anomalies/trends in real-time for any requested combination of dimensions tracked by the time-series data. A dimension represents a particular type of data. For example, a dimension might be a language, a status, a service provider, a temperature, etc. The label indicates the value of the dimension. For example, a status dimension may have the labels “pending,” “approved,” and “denied” and a temperature dimension may have any number that represents a temperature measurement as a label. The detection system takes as parameters one or more of these dimensions. The detection system identifies, from all possible combinations of the dimension labels in a large number (millions or billions) of time-series the data points, which data points might represent an anomaly. For example, if the parameters identify a status and transaction type, the system determines which unique combinations of status and transaction type labels (e.g., <pending, deposit>, <approved, transfer>, <pending, transfer>, <denied, deposit>, etc.) exist in the event repository for specified time intervals. These unique combinations can be referred to as unique dimension labels or as slices. The detection system compares an aggregate value (or values) for the different unique combinations and determines which are interesting, e.g., which are candidates for further analysis. The detection system performs the intensive computations to train a forecasting model only for those candidates selected for further analysis. The detection system determines, using the forecasting model, whether the candidate represents an anomaly. Because the detection system eliminates a vast majority of the potential combinations of dimension labels, the system can operate in real time even without knowing which combination of dimensions to model ahead of time.

Disclosed implementations first query the event repository for time-series data that can be used to identify and analyze unique combinations of the requested dimensions. The analysis compares an aggregate value for a test interval with aggregate values for each of one or more reference intervals. The test interval, or data from which to determine the test interval, may be provided as a parameter. The reference intervals, or data from which to determine the reference intervals, may also be provided as a parameter. In some implementations, the reference interval may be determined from information for the test interval. The analysis of the data in the test and reference intervals enables the detection system to quickly select anomaly candidates. For one dimension provided as a parameter an anomaly candidate is a unique dimension label. For two or more dimensions provided as parameters, an anomaly candidate is a unique combination of dimension labels, the combination including a label for each dimension provided as a parameter. The system may perform a full forecasting analysis, e.g., training and using a forecasting model, on the few anomaly candidates identified by the candidate selection process. Forecasting can be used to determine whether a recent value for the anomaly candidate is far enough outside of the forecast value to qualify as an anomaly. If so, the detection system can provide the dimension labels as a response, e.g., for reporting or further processing.

Disclosed implementations can be implemented to realize one or more of the following advantages. For example, the system can provide anomaly detection in real-time even for a previously unknown combination of dimensions, so long as the dimensions are captured in the time-series repository. As another example, the detection system has a tree-like structure. The tree-like structure scales to billions of data points roughly linearly with the number of leaves added. In other words, implementations can scale to billions of time-series while still achieving real-time latency. Large-scale detection systems present inherent scalability challenges, particularly when used for applications having extreme low-latency requirements, e.g., providing real time alerts for applications related to financial transactions, mechanical systems, fraud detection, malware identification, etc. Many forecasting and anomaly detection systems observe a predetermined domain threshold over time or dynamically adjust a resolution interval. But such systems do not scale to hundreds of billions of data points and either rely on large scale batch jobs (sacrificing latency) or only run over a subset of the data (sacrificing recall). In contrast, disclosed implementations can run over the entire event repository in real time because the computationally intensive work of training a forecasting model is only performed for relatively few dimension combinations. That is, candidate dimension combinations are identified and forecasting models are performed based on the identified dimension combinations rather than on every dimension contribution, significantly reducing the computation burden. As another example, disclosed implementations can be offered as a service to any time-series repository. Implementations are flexible and highly customizable to the underlying data points. Implementations can be run in batch as well as real-time.

The details of one or more implementations are set forth in the accompanying drawings and the description below. Other features, aspects, and advantages of the subject matter will become apparent from the description, the drawings, and the claims.

### BRIEF DESCRIPTION OF DRAWINGS

FIG. 1 illustrates an example detection system used for identifying anomalies from an event repository based on requested dimensions, in accordance with the disclosed subject matter.

FIG. 2 is a flowchart of an example process for identifying anomalies in requested dimensions from a time series, in accordance with the disclosed subject matter.

FIG. 3 is a flowchart of an example process for evaluating anomaly candidates, in accordance with disclosed subject matter.

FIG. 4 is an example event repository, in accordance with the disclosed subject matter.

FIG. 5 illustrates example anomaly candidate selection based on the example event repository of FIG. 4 and disclosed implementations.

FIG. 6 shows an example of a computer device that can be used to implement the described techniques.

FIG. 7 shows an example of a distributed computer device that can be used to implement the described techniques.

Like reference symbols in the various drawings indicate like elements.

Implementations provide an enhancement to event tracking systems by identifying anomalies for requested dimensions from a typed event time-series repository. Implementations can identify anomaly candidate slices using an index of typed events. Implementations can build a forecasting model for just those candidate slices using historical data from the typed event time-series repository and use the forecasting model to predict whether the slice represents an anomaly or not.

As used herein, time-series data means data representing an event that occurred during a particular time period. The event is associated with one or more data points. Each data point has a dimension. Each dimension may be associated in the time-series with a particular timestamp and have a label. The label represents a value for the dimension. For example, if the dimension is “language” then a dimension label may be “English,” “Russian,” “Japanese,” etc. Similarly, if the dimension is “pressure” then a dimension label may be a number representing a pressure measurement. A time-series data point may include an indication of the dimension and an indication of the label for the timestamp. In some implementations, each time-series data point has an implied value representing an occurrence count, i.e., a count of one (1). In some implementations, a time-series data point has an express value representing a count, which could be one or a number higher than one. In some implementations, a time-series data point has an express value that represents another kind of value appropriate for an aggregate function, e.g., an average, a maximum, a median, a minimum, a sum, etc.

The time-series data may be kept for a short time period. The length of the short time period may be a system-tunable parameter. The time-series event repository may only maintain enough historical time-series data to provide accurate forecasting. For real-time anomaly detection, this may be a few weeks, a few days, or even a few hours depending on the type of event(s) being analyzed. Thus, the short time period may typically be on the order of minutes, hours, or days, rather than months or years.

The event time-series data, e.g., the dimensions relating to a particular event, can be organized in a number of different ways. For example, the system can generate a single document that includes data representing all dimensions that co-occurred at a single time or during a single time period. As another example, the repository can store each data point as a separate record. As another example, the repository may be an inverted index. For example, a dimension label may be stored with a list of timestamps or with a list of documents representing different timestamps. Suitable techniques for an event index are described in U.S. Patent Publication No. 2018/0314742, for “Cloud Inference System,” which is incorporated by reference. In some implementations, the inverted index can be arranged in a tree-based hierarchy with a root server, multiple intermediate servers in one or more levels, and multiple leaf servers. In such a system, the root server sends a query to each of the leaf servers and each of the leaf servers replies with any responsive event data points. The root server may then perform an n-way merge of returned data. This arrangement allows the collection of indexed data to be searched in real-time, which is important where the scale of searchable dimensions prevents a complete index from being pre-generated.

A trend is an anomaly with a directionality. For example, a breaking news story may indicate a trend when it occurs more frequently (rather than less frequently) than the time series data predicts. Thus, as used herein, any reference to an anomaly can also apply to a trend when directionality is also considered.

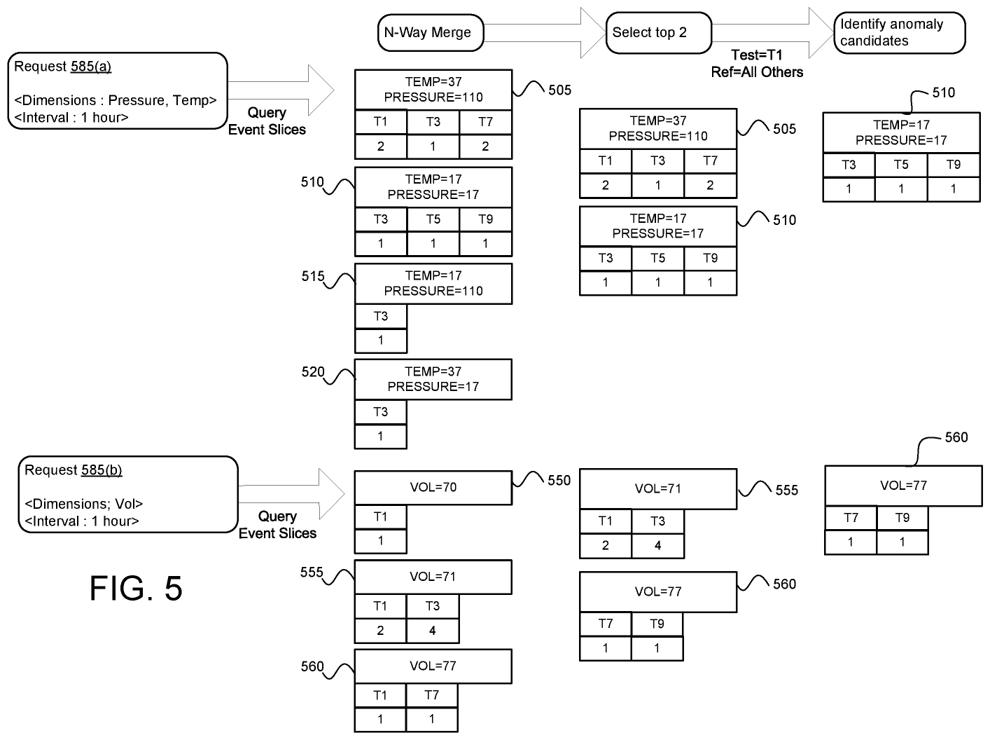

As used herein, a slice represents a combination of label values over some dimensions, i.e., the dimensions provided as parameters. A slice thus represents a unique combination of dimension labels, with one label per dimension. As illustrated in FIG. 5, if the dimensions of “pressure” and “temperature” are requested, a slice may be a unique combination of a pressure label and a temperature label. As used herein, when a slice represents two or more dimensions, both dimensions must have a label for the requested interval.

As used herein, a test interval is a time period used to select anomaly candidates for full forecast prediction analysis. The test interval can be provided as a parameter. For example, a requesting process may provide a start time as a parameter and the detection system assumes a duration. As another example, a requesting process may provide a start time and a duration as parameters and the detection uses the start time and duration to define the test interval.

As used herein, a reference interval is a time period that occurs before the test interval and has a duration that is a multiple of the duration of the test interval. The detection system may operate using a plurality of reference intervals. In some implementations, the reference intervals may be determined from the test interval. For example, the reference intervals may be assumed to be periods of time occurring prior to the test interval, e.g., starting one hour, 5 hours, 1 day, etc. before the test interval. In some implementations, the requesting process may provide information from which to determine the reference intervals. For example, the requesting process may provide a start time for the reference intervals. The detection system may generate some number of reference intervals with the first reference interval starting at the start time. The requesting process may provide an age for the reference intervals. In such implementations, the detection system may subtract the age from the test interval start time and generate some number of reference intervals starting at that time. The requesting process may provide a start time and a duration for each of a plurality of intervals. In such an implementation, the detection system may generate a reference interval for each provided start time and duration.

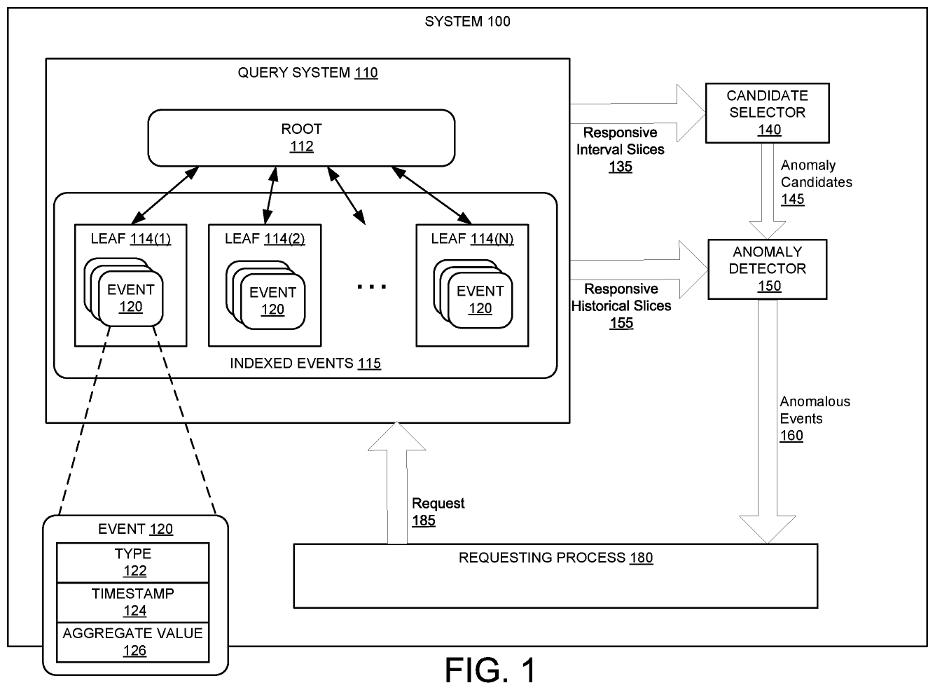

FIG. 1 is a block diagram of an anomaly detection system in accordance with an example implementation. The system 100 may be used to identify unique dimension labels or combination of dimension labels, i.e., slices, that represent an anomaly in an event monitoring system. The system 100 can operate in real time even though the dimensions requested are not known ahead of time. However, the system 100 can also operate in an offline mode, e.g. where the query system does not support obtaining data in a real-time manner or real-time feedback is not needed. For ease of description, the depiction of system 100 in FIG. 1 is sometimes described as processing certain dimensions (e.g., pressure, volume, temperature, etc.) but implementations can operate on any type event time-series data.

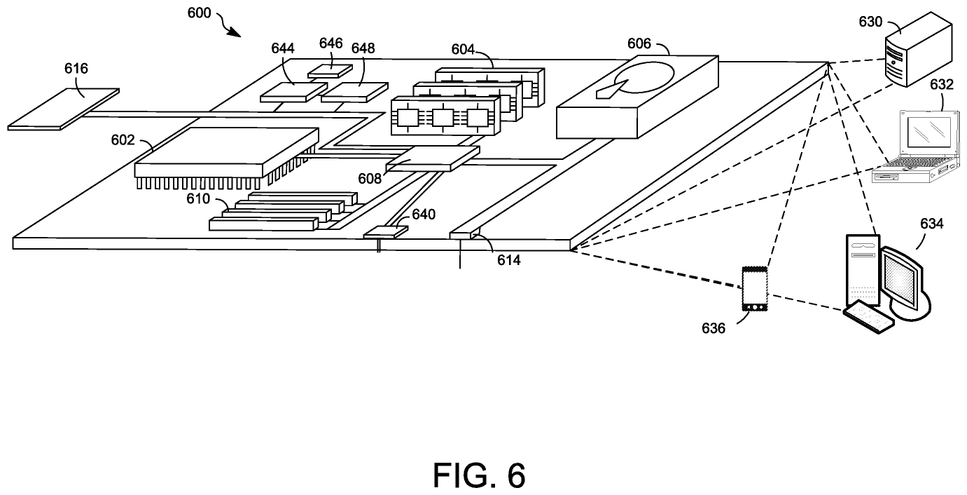

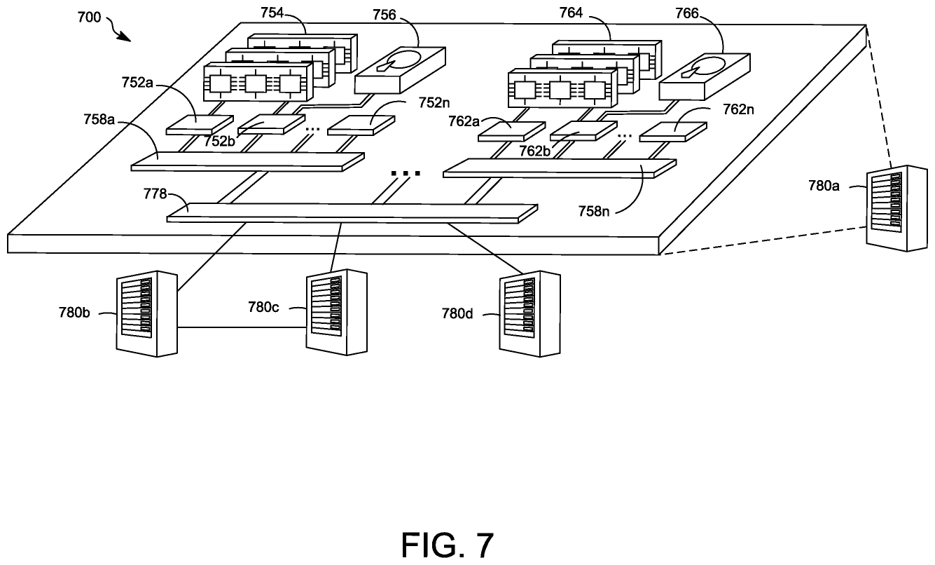

The salient feature extraction system 100 may be a computing device or devices that take the form of a number of different devices, for example, a standard server, a group of such servers, or a rack server system, etc. In addition, system 100 may be implemented in a personal computer, for example, a laptop computer. The system 100 may be an example of computer device 600, as depicted in FIG. 6 or computer device 700, as depicted in FIG. 7.

Although not shown in FIG. 1, the system 100 can include one or more processors formed in a substrate configured to execute one or more machine executable instructions or pieces of software, firmware, or a combination thereof. The processors can be semiconductor-based—that is, the processors can include semiconductor material that can perform digital logic. The processors can be specialty processors, such as graphics processing units (GPUs). The system 100 can also include an operating system and one or more computer memories, for example a main memory, configured to store one or more pieces of data, either temporarily, permanently, semi-permanently, or a combination thereof. The memory may include any type of storage device that stores information in a format that can be read and/or executed by the one or more processors. The memory may include volatile memory, non-volatile memory, or a combination thereof, and store modules that, when executed by the one or more processors, perform certain operations. In some implementations, the modules may be stored in an external storage device and loaded into the memory of system 100.

The system 100 includes an example requesting process 180, which is an example of a requesting process that uses a detection system 100 to identify anomalies for any requested dimensions in real-time from typed, time-series data. The typed, time-series data is represented as indexed events 115. The indexed events 115 may also be referred to as an event repository. The indexed events 115 are typed because they have an associated dimension and dimension label. An individual time-series data point is represented by event 120. Each individual event 120 may include a type 122 and a timestamp 124. The type 122 is the dimension and dimension label for the event. Thus, <pressure, 15>, <status, pending>, and <transaction, deposit> are nonexclusive examples of types represented by type 122. The timestamp 124 represents a particular time period. The granularity of the time period is dependent on the type of data represented by the event data points. For example, banking transactions may have a very short time period and the timestamp 124 for such events may record the date, hour, minute, and second, or even tenths of a second. Conversely, some monitoring systems may only process an event every five minutes, so the time period of the timestamp 124 may only record the date, hours, and minute.

Some events 120 may also have an aggregate value 126. The aggregate value 126 represents some value that can be used in an aggregate function. Examples of aggregate functions include a count, a sum, an average, etc. In some implementations, the aggregate value 126 is implied and not actually stored. For example, if the aggregate value for the event 120 is a count, the existence of the event 120 may be considered a value of one (1), or in other words, a count of one (1) for the type of the event. In some implementations, the count may be explicitly stored.

In some implementations, the indexed events 115 may be stored as an inverted index. In an inverted index, the events 120 may be stored in a way that associates the dimension label with a list of the time series in which that type of event occurred. Thus, for example, the <pressure, 15> type may be associated with three different timestamps. Implementations also cover alternative arrangements, for example where the timestamps are associated with a group or document identifier. In this case, <pressure, 15> may be associated with three document identifiers, and the three timestamps may be located using the document identifier. The time-correlated events having different types (dimension labels) allows the detection system to make aggregate cross-dimension detections without knowing ahead of time which dimensions to include in the cross.

In the example of FIG. 1, the indexed events 115 represents a distributed inverted index, where typed events are sharded among several leaf servers 114. Each leaf server 114 (e.g., leaf 114(1), leaf 114(2) . . . leaf 114(n)) may store a unique portion of the index or may store a replica. Access to the events 120 in the leaf servers 114 may be controlled by a root server 112. The root server 112 of the query system 110 may receive query requests and may distribute the query to the leaf servers 114. The leaf servers 114 may provide any responsive event data points to the root server 112. Although not illustrated in FIG. 1, the query system 110 may include one or more intermediate servers between the root server 112 and the leaf servers 114. Implementations also include indexed events 115 that have a format other than an inverted index. But for index repositories that store billions of data points, such formats may not be capable of responding as quickly as a distributed inverted index.

In the example of FIG. 1, the indexed events 115 are illustrated as part of the detection system 100. But in some implementations, the indexed events 115 may be remote from, but accessible by the detection system 100. Similarly, the example of FIG. 1 illustrates the query system 110 as part of the detection system 100, but query system 110 may also be remote from, but accessible by the detection system 100. In other words, the detection system 100 may use an interface to the query system 110 to request and receive events from the indexed events 115.

The query system 110 takes as input one or more dimensions. The dimensions are provided in a request 185 from the requesting process 180. The dimensions provide in the request define a dimension combination. Although illustrated in FIG. 1 as included in detection system 100, the requesting process 180 may be separate from but in communication with the detection system 100. For example, the requesting process 180 may provide request 185 via an API for the detection system 100. In some implementations, the request 185 may also include information about different time periods used in the anomaly or trend detection process. If such information is not provided, the system 100 may use default values. Example time periods include a test interval and one or more reference intervals used in the candidate selector 140 and a history duration used in the anomaly detector. For example, the request 185 may include a start time for the test interval. In some implementations, the query system 110 uses a default test interval duration and the test interval start time to define a test interval. In some implementations, the test interval duration is also provided in the request 185.

In some implementations, the reference intervals may be determined from the test interval. Reference intervals all occur prior to the test interval start time. In some implementations, a reference interval age may be provided as part of the request 185. The system 100 may determine a reference interval start time by subtracting the reference interval age from the test interval start time. In some implementations, a respective reference interval age may be provided in the request 185 for each reference interval. In some implementations, the request intervals are not relative to or determined from the test interval. For example, the request 185 may include a respective start time for each of one or more reference intervals. In some implementations, the system 100 may use a default duration for each reference interval. In some implementations, the default duration may be the same for each reference interval. In some implementations, the default duration may be different for some reference intervals. In some implementations, the duration of a reference interval is a multiple of the test interval. The multiple can be 1, 2, 3, 4, etc. If the duration of a reference interval is longer than the test interval duration (e.g., the multiple is 2 or more), the system may average the aggregate value over the number of test intervals in the reference interval. Thus, for example, if the reference interval is 5 hours, but the test interval is one hour, the system 100 may find the aggregate value for each 1 hour duration of the 5 hours and then average the 5 aggregate values.

The request 185 may also include other parameters, such as a history duration. The history duration is an indication of how far back the anomaly detector 150 should look to obtain time-series data to train a forecasting model. If a history duration is not provided in the request 185, the system 100 may use a default history duration. Other optional parameters include flags relating to what is included in the response. For example, the system 100 can optionally return the anomaly candidates 145 that were evaluated by the anomaly detector 150 and/or the responsive interval slices 135 in addition to the anomalous events 160. Optional parameters in the request 185 may also provide various thresholds and comparison values used by the candidate selector 140 and the anomaly detector 150. For example, the request 185 may include parameters for a relative change threshold, an absolute change threshold, maximum error thresholds used to evaluate the forecasting model, among other variables described herein. Thus, the detection system 100 can provide a highly customizable process via an API.

The query system 110 uses the parameters (and/or default values) to determine a test interval and the reference intervals. The query system 110 then queries the indexed events 115 to identify responsive events in each interval. Responsive events are those data points that match the requested dimension (regardless of the label of the dimension) and have a timestamp that falls within the test interval or the reference intervals. For each interval, when the responsive events are returned, the query system 110 performs an n-way merge interval slices 135. The n-way merge combines the events that have the same dimension labels/dimension label combinations by aggregating the aggregate value. For example, if the aggregate value is a count and the query parameter specifies dimension1, each instance of a particular <dimension1, label(x)> is a responsive interval slice with an associated count that represents the number of times that label(x) was found in the interval, where label(x) is any unique label for dimension1. If the query parameters specify two or more dimensions, each responsive interval slice is a unique combination of dimension labels with its own associated aggregate value. For example, if status and transaction are the requested dimensions, then the dimension combination is a combination of a status label and a transaction label. The query system 110 returns each instance where any label for status co-occurs with any label for transaction. Co-occurrence means that a data point with the status label has the same timestamp as the data point with the transaction label. In other words, status and transaction are dimensions of the same event, which has a single timestamp. The number of times that cancelled for status co-occurs with withdrawal for transaction is the aggregate value for the interval slice <status, cancelled, transaction, withdrawal>. Of course, other aggregate functions may be similarly applied.

In some implementations, when a reference interval has a duration that is longer than the test interval, the n-way merge calculates the aggregate value for each test interval duration within the reference interval and then averages these aggregate values. Thus, for example if the test interval duration for the example above is one minute and a reference interval is a five minute period of time, the n-way merge will determine the count of the unique combination of dimension labels occur in each minute of the five minute period and then calculate the average of the counts. This average of the five counts is the aggregate value for this particular reference interval. While the system 100 is described as calculating one aggregate value (e.g., a count) for each interval for each slice, the system 100 could calculate multiple aggregate values, e.g., a count and an average for each interval for each slice.

The detection system 100 provides the responsive interval slices 135 (i.e., unique combinations of labels for the dimensions requested) to the candidate selector 140. The candidate selector 140 is configured to determine which slices might represent an anomaly by comparing the aggregate value in the test interval with the aggregate values in the reference intervals. In some implementations, the candidate selector 140 may be configured to select only the top k interval slices. In some implementations, the top k interval slices are the slices that occur most often across all intervals, i.e., the test interval and all reference intervals. The count used to determine occurrence can be the aggregate value for the interval or can be calculated separately from or in addition to the aggregate value for the interval. The value of k may be a parameter supplied in the request 185 or may be a default, e.g., two, three, five, eight, ten, etc.

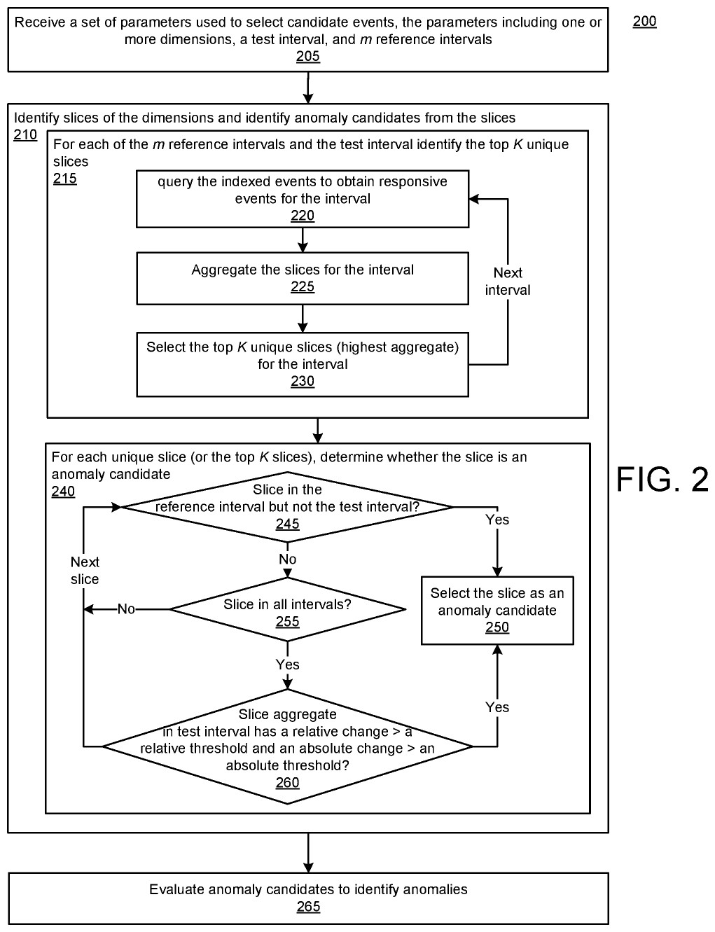

The candidate selector 140 may determine whether each of the top k slices (or each unique slice) is an anomaly candidate based on the test and reference intervals. The candidate selector 140 may select a slice as an anomaly candidate 145 if the slice is present in a reference interval but not in the test interval. The candidate selector 140 may select a slice as an anomaly candidate 145 if the slice is present in all intervals, but has a sufficiently different aggregate value in the test interval than in one of the reference intervals. Whether the aggregate value is sufficiently different is described in more detail with regard to FIG. 2.

Any anomaly candidates 145 are provided to the anomaly detector 150. The anomaly detector 150 may be configured to, for each candidate slice, fetch a time series for the slice over a historical period. The historical period may be defined by a history duration provided as a parameter or defined by a default period. The anomaly detector 150 may use the historical time series to train a forecasting model. The anomaly detector 150 may use any known or later developed forecasting model. Example forecasting models include linear regression, simple moving average, LOESS (Locally Estimated Scatterplot Smoothing) with or without STL, etc. The model used may be dependent upon the length of the historical period. For example, shorter periods may use a moving average and longer periods may use LOESS. The anomaly detector 150 may use the forecasting model to generate a predicted, or forecast, value and then compare that value with an actual value from the indexed events 115. If the values differ significantly, the anomaly detector 150 returns the slice as an anomalous event 160.

Accordingly, for each anomaly candidate 145, the anomaly detector 150 may query the indexed events 115, e.g., via query system 110, for events responsive to the candidate slice. An event is responsive to the candidate slice if the event falls within the historical period or an evaluation interval and match the combination of dimensions and labels represented by the slice. The evaluation interval may have an evaluation duration. The evaluation duration may be the same as the test interval duration used to identify candidate slices. The evaluation duration may be different than the test interval duration. The query system 110 may perform an n-way merge of the responsive events. The n-way merge may merge events from the different leaf servers 114 and generate aggregate values for each evaluation duration in the historical data. The evaluation interval may be provided as part of the parameters in the request 185, e.g., by specifying the interval or information from which to determine the evaluation interval.

The anomaly detector 150 may use the aggregate values for the historical time-series data (e.g., the values calculated for the evaluation duration) to train a forecasting model. The anomaly detector 150 can train the forecasting model using a first portion of the historical data, also referred to as a test portion. The anomaly detector 150 may use the remaining portion of the historical data to evaluate the quality of the forecasting model. This remaining portion may be referred to as a holdout portion and is not used in training the forecasting model. The holdout portion may be used to compute training errors, or in other words determine the confidence of a prediction by the forecasting model.

Example training errors are MdAPE (median absolute percentage error) and RMD (relative mean deviation). These training errors measure the fitting interval, e.g., how accurate the model is. The anomaly detector 150 may disregard forecasting models that have high training errors, or in other words low confidence. To determine if the forecasting model has high training errors, the MdAPE may be compared to an MdAPE threshold. This threshold can be provided as a parameter in the request 185. If the MdAPE meets or exceeds the MdAPE threshold the model may be considered to have high training error. Likewise, an RMD error for the model may be compared to an RMD threshold. If the RMD error meets or exceeds this threshold the model may be considered to have high training error. The RMD threshold can be provided as a parameter in the request 185. In some implementations, a combination of the MdAPE and RMD error, or some other error measurement, may be used.

In some implementations, if the training error is too high, the anomaly detector 150 may stop processing the candidate. In some implementations, if the training error is too high, the anomaly detector 150 may break up the slice, or in other words use fewer dimensions in the slice and reevaluate, e.g., putting the different dimension combinations through the candidate selection process. This may increase the number of occurrences and may lead to a better model. In any case, a candidate slice that produced a model with low confidence will not be further evaluation for anomaly detection.

If the forecasting model has adequate confidence, the anomaly detector 150 may query the event index 115 for responsive events (events matching the dimension and labels in the candidate slice) that occur in a recent evaluation interval. These events may be merged and an aggregate value generated. This aggregate value represents an actual value, or actualᵥₐₗ. The anomaly detector 150 may compare this actual value to a forecast value predicted for the same interval by the forecast model.

The anomaly detector 150 may calculate a confidence interval for the forecasting model based on the holdout portion. The confidence interval may be based on a measurement of the performance of the forecasting model, e.g., a log accuracy ratio. The log accuracy ratio may be represented by |ln(holdoutᵥₐₗ)/(forecastᵥₐₗ)| for each evaluation duration in the holdout portion of the historical time-series. Holdoutᵥₐₗ is the value from the holdout portion of the historical time-series data for a particular interval and forecastᵥₐₗ is the predicted value for that interval from the forecasting model. In some implementations an extra weight may be added to avoid empty time buckets. In this case the log accuracy ratio may be represented as |ln(holdoutᵥₐₗ+extra_weight)/(forecastᵥₐₗ+extra_weight)|. The extra_weight may reflect a sensitivity to differences between the forecast and holdout values. For example, the extra_weight may be small, e.g., 1.0 for applications sensitive to differences but may be large, e.g, 100 or 1000, for applications less sensitive to divergent values. The value of the extra_weight parameter can thus be implementation dependent and may be provided as one of the parameters.

Once the distribution of the log accuracy ratio is known over the holdout portion, the anomaly detector 150 may compute the confidence interval. In some implementations, the confidence interval may be a 99% confidence interval. In some implementations, the confidence interval may be a 95% confidence interval. The confidence interval used may be based on the confidence in the forecasting model. For example, a forecasting model with low error (e.g., MdAPE and/or RMD) may use a 99% confidence interval while a forecasting with moderate error may use a lower confidence interval, e.g., 95%. The 99% confidence interval represents the range of values the model is 99% confident that the real (actual) value lies within. The 95% confidence interval represents the range of values that the model is 95% confident that the real (actual) value lies within. Each confidence interval has an upper bound. The anomaly detector 150 may use the upper bound (i.e., error_ci) to determine whether the actual value from the event index differs by a predetermined amount from the forecast value provided by the trained forecasting model.

In some implementations, the anomaly detector 150 may consider a candidate slice an anomaly when either of the following conditions are true:

1. e\hat{ }error_ci*(forecastᵥₐₗ+extra_weight)>(actualᵥₐₗ+extra_weight)*max_delta
2. actualᵥₐₗ+extra_weight<(e\hat{ }error_ci*(forecastᵥₐₗ+extra_weight)/max_delta
where max_delta is a maximum difference between the actual and forecasted values and e is Euler's number. Max_delta may be provided as a parameter in request 185 or may be a default value. Max_delta is configurable to the type of events being evaluated and represents the level of tolerance for anomalous values. If the actualᵥₐₗ fails either test, the anomaly detector 150 considers the actualᵥₐₗ outside of a predetermined range of the forecastᵥₐₗ and the candidate slice is considered anomalous. These slices are returned as anomalous events 160.

Because training the forecasting model is computationally expensive and time consuming, the detection system 100 minimizes the number of forecasting models that need to be trained (or in other words generated) through the candidate selection process. Thus, although there may be hundreds or even thousands of potential slices (e.g., representing a cross product of the possible labels for the different dimensions), only a few slices are selected for full forecasting analysis. The candidate selection process can be done in hundreds of milliseconds using indexed events 115 with a distributed, inverted index structure. The resources (RAM and CPU) used to compute the top slices scale linearly with the number of slices and are almost independent of the number of dimensions. For example, computing the top 20k slices with six dimensions can be done in less than one second and computing the top 100k slices with 10 dimensions in under 10 seconds.

The system 100 may include or be in communication with other computing devices (not shown). For example, the requesting process 180 may be remote from but able to communicate with the detection system 100. Likewise, the query system 110 may be remote from but able to communicate with the detection system 100. Thus, the system 100 may be implemented in a plurality of computing devices in communication with each other. Thus, detection system 100 represents one example configuration and other configurations are possible. In addition, components of system 100 may be combined or distributed in a manner differently than illustrated.

FIG. 2 is a flowchart of an example process for identifying anomalies in requested dimensions from a time series, in accordance with disclosed subject matter. Process 200 may be performed by a detection system, such as system 100 of FIG. 1. Process 200 may be performed in real-time or in an offline or batch manner. How fast anomalies are detected can be dependent on the structure of the event repository (e.g., indexed events 115), on the computing resources (e.g., processors and memory), and the number of slice candidates identified. Process 200 may begin by receiving a set of parameters (205). Process 200 may be highly flexible and customizable. While a high number of parameters can be provided, implementations may use default values if such parameters are not provided. At a minimum, the set of parameters includes at least one dimension. The dimension or dimensions are used to select the time-series data to focus on in the event repository. The dimensions in the parameter set may lack a corresponding label. In such an implementation any label for the dimension is considered responsive to a query for the dimension. One or more dimensions in the parameter set may have a requested label or labels. In such an implementation, only labels for the dimension matching the label(s) from the set of parameters is considered responsive to a query for the dimension. In some implementations, the set of parameters may include a test interval or data from which to calculate a test interval. For example, the set of parameters may indicate a test start time. The test start time defines the start of the test interval. The set of parameters may include a test duration. In such an implementation, the test duration defines the duration of the test interval, which starts at the test start time. In some implementations, a default test duration is used when the test duration is not provided in the set of parameters.

The set of parameters may include information from which to determine m (m being one or more) reference intervals. The reference intervals all occur prior to the start time of the test interval. The reference intervals all have a duration that is a multiple (e.g., 1, 2, 3, etc.). of the duration of the test interval. Not every reference interval needs to have the same duration. For example, a first reference interval may have a duration matching the test interval duration while a second interval may have a duration twice as long as the test interval duration. In some implementations, the start time and duration of each of the m reference intervals may be provided in the set of parameters. In some implementations, the age of each of the m reference intervals may be provided and the start time of the interval may be calculated based on the start time of the test interval, e.g., test interval start time minus the age. The duration of the reference interval may be assumed to be the same as the test interval until a different duration is provided. In some implementations the age and duration of the reference intervals may be assumed if no information is provided in the set of parameters.

The set of parameters can also include other parameters. Examples of such parameters may be whether anomaly candidate slices are returned in addition to anomalies, whether responsive event slices are returned with the anomalies, the duration of the history time series for training the forecast model, a duration of an evaluation interval, the maximum difference between the actual and forecasted values over the evaluation interval, a minimum absolute change for selecting candidate slices, a minimum relative change for selecting candidate slices, a forecast time-series count offset, a forecast extra weight, a forecast MdAPE threshold, a forecast RMD threshold, etc. Not all of the parameters listed must be provided and default values may be used if not provided. The set of parameters may be provided as part of an API for the detection system.

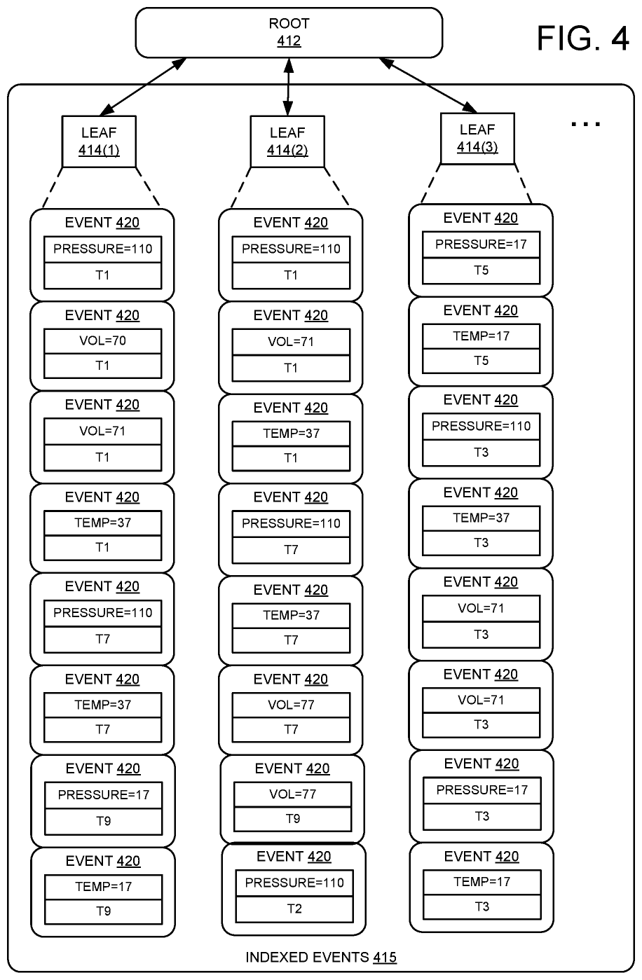

The system may use the set of parameters to identify slices of the requested dimensions and analyze the slices to identify anomaly candidate slices (210). The identification of anomaly candidates using reference intervals is a coarse-grain filter. This course-grain filter identifies slices that are interesting, or in other words that are more likely to represent an anomaly. In implementations that use the coarse-grain filter based on comparison of a test interval with reference intervals, the system is able to minimize more computationally-intensive anomaly detection. For example, the system may first determine the test interval and the m reference intervals defined by the parameters and/or default values. For each of the intervals (e.g., for the test interval and each of the m reference intervals), the system may determine the top k unique slices in the interval (215). In order to find the top k unique slices for an interval, the system may query the event repository, such as indexed events 115, for responsive events for the interval (220). The event repository query may specify the dimensions (and optionally, any labels for a particular dimension) and the interval. The query returns all data points that match the query parameters, e.g., for the specified dimension (and optionally, a label matching a specified dimension label) that occur within the interval. The system may aggregate the data points for the interval, e.g., determining which unique combinations of dimension labels occur within the interval. Each unique combination of dimension labels is an event slice, or just a slice. Using the example event index 415 of FIG. 4 and the request 585(a) of FIG. 5, interval T1 has one slice, <Temp=37, Pressure=110>, which represents the unique combinations of the Pressure dimension and the Temperature dimension. In contrast, interval T3 has four slices; <Temp=37, Pressure=110>, <Temp=17, Pressure=17>, <Temp=37, Pressure=17> and <Temp=17, Pressure=110>. In other words, the slices represent a cross product of the labels that occur in the interval for the requested dimensions.

The system calculates an aggregate value for each slice (225). The aggregate value can be an occurrence for the slice in the interval, or in other words the number of times that particular combination occurs in the slice. The aggregate value can be calculated from an aggregate value stored in the index, e.g., averaging the averages. In some implementations, the system may calculate more than one aggregate value, e.g., calculating a count and an average, for each slice. In some implementations, where the interval is a reference interval with a duration longer than the test duration, the system may calculate the aggregate value for a time period within the reference interval equal to the test duration and average the aggregate values for these durations. For example, if the test interval is 5 minutes and the reference interval is an hour, the system may calculate the aggregate value (e.g., the count) for every five minute interval within the hour and then average the twelve count values. The average is considered the aggregate value for the reference interval. In some implementations, the system may treat the one hour reference interval as twelve different reference intervals.

In some implementations, the system selects a predetermined number of the slices for further consideration (230). For example, the system may select the top k slices. A slice may be considered a top k slice if it is one of the k slices with highest occurrence across all intervals. Using FIG. 5 where k=2 as an example, the <Temp=37, Pressure=110> and <Temp=17, Pressure=17> slices are selected because they have an occurrence of 5 and 3 respectively, where the remaining slices have an occurrence of 1 each. Similarly, for a separate request 185(b), the slices <Vol=71> and <Vol=77> are selected because they have higher occurrence than the slice of <Vol=70>. In some implementations, the system may select the top k slices if the number of slices exceeds a threshold.

The system may analyze the unique slices (or the top k unique slices) to determine whether the slice is an anomaly candidate (240). The system may consider a slice to be an anomaly candidate if the slice is in any one of the m reference intervals but fails to appear in the test interval (245, Yes). If the slice is in a reference interval but not the test interval, the system may select or mark the slice as an anomaly candidate (250). If the slice does appear in the test interval (245, No), in some implementations the system may determine whether the slice appears in all of the reference intervals (255). If the slice is not in all the reference intervals (255, No), the system may not consider the slice an anomaly candidate. If the slice is in all intervals (255, Yes), the system may determine whether a relative change between the test interval and any one reference interval exceeds a relative change threshold (260). The relative change threshold can be one of the parameters provided with the original request. The relative change can be calculated according to |referenceᵥₐₗ−testᵥₐₗ|/(referenceᵥₐₗ+testᵥₐₗ) where referenceᵥₐₗ is the aggregate value for one of the m reference intervals and testᵥₐₗ is the aggregate value for the test interval. If this relative change meets or exceeds the relative change threshold (260, Yes), the system may consider the slice an anomaly candidate (250). The system performs this relative change test against each of the m reference intervals.

In some implementations, in addition to checking the relative change, the system may also check an absolute change. For example, if the relative change meets or exceeds the relative threshold, the system may determine whether the absolute difference between the test interval and the reference interval meets or exceeds an absolute threshold. The absolute difference comparison may be used to filter out noise which is more likely at low occurrences. In other words, the absolute threshold comparison may keep the candidate selection process from selecting noisy slices, e.g., slices without sufficient data to make the relevant threshold meaningful.

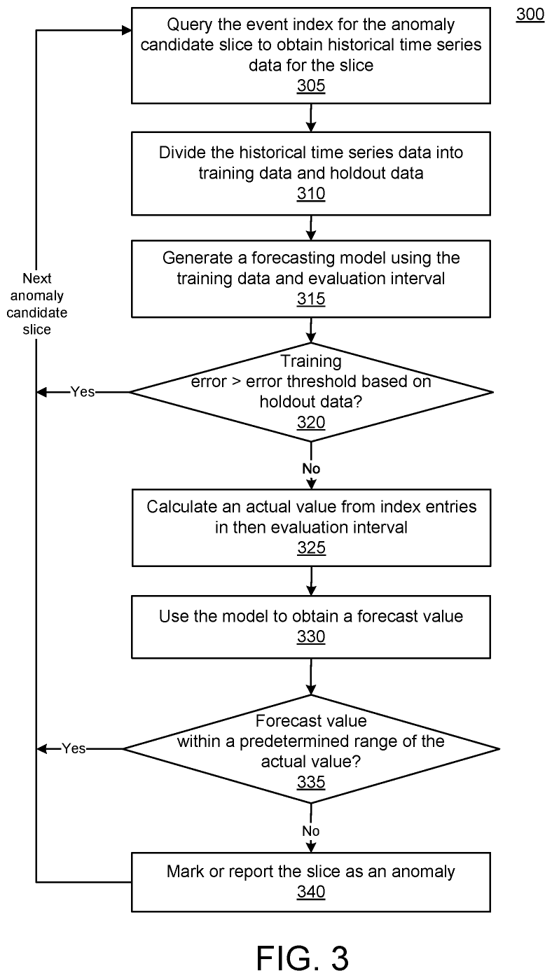

After identifying the anomaly candidates (e.g., those slices determined to have a sufficient relative change or a sufficient relative change and a sufficient absolute change), the system may evaluate the anomaly candidates to identify slices that represent anomalies (265). An example of this process is explained in more detail with regard to FIG. 3. In some implementations, the further evaluation is optional and the system may return the candidate slices to the requesting process for further evaluation. Once anomalies are identified, these slices can be returned to the requesting process. The requesting process can choose to perform further analysis, send an alert, add the slices to a watch list, etc. In addition to the anomaly slices, and depending on the parameters of the request, the system may also provide one or more of the candidate slices, the unique slices analyzed to determine the anomaly candidates, or the top k unique slices. Process 200 then ends.

FIG. 3 illustrates a flowchart of an example process 300 for evaluating anomaly candidates, in accordance with disclosed subject matter. Process 300 may be performed by an anomaly/trend detection system, such as system 100 of FIG. 1. Process 300 may be performed as part of step 265 of FIG. 2. Process 300 may begin by querying the event repository for the dimension labels represented by the anomaly candidate slice that occur during a specified historical time period to obtain historical time series data for the slice (305). The start time of the specified historical time period may be a default value or may be provided as part of the parameters of the original request (e.g., request 185 of FIG. 1 or the parameters referred to in step 205 of FIG. 2). The duration of the specified historical time period may be a default value or may be provided as a parameter of the original request. The historical time period represents a time period sufficient for training a forecasting model. The duration of the historical time period should be a multiple of a duration for an evaluation interval used in the anomaly analysis of process 300. This evaluation interval duration can be the same as or different than the test interval duration used to determine anomaly candidates.

The system may determine an aggregate value for each evaluation duration in the historical time series data. Thus, for example, if the historical time period is three days and the evaluation duration is an hour, the system determines an aggregate value for each hour of the 72 hours in the three-day period. The 72 one-hour periods with the respective aggregate value(s) are considered the historical time-series data for the slice. In some implementations, the historical time period may be broken up; e.g., including 36 hours total over a week. The system may divide the historical time-series data into a training portion (training data) and a holdout portion (holdout data) (310). The training portion may thus represent a first portion of the historical time-series data. The training data may represent a majority of the historical time-series data. In some implementations, the parameters of the original request may include a percentage used to determine what percent of the historical time-series data is holdout data. The training data may be used to train a forecasting model (315). The holdout portion may be used to evaluate and guide the training. The forecasting model can be any time-series prediction model. The forecasting model may be any model suitable for the type of data being analyzed. Non-exclusive examples of forecasting models include simple moving average, LOESS, LOWESS, regression, etc.

As part of evaluating the model, the system may calculate one or more training errors. The training error may be a median absolute percentage error (MdAPE). The training error may be a relative mean deviation (RMD). The training errors may be used to determine the quality of the forecasting model. For example, an MdAPE error may be compared to a maximum MdAPE threshold and if the MdAPE error meets or exceeds this threshold (320, Yes), the model's error is too high. Likewise, an RMD error may be compared to an RMD threshold. In some implementations, the system may use both errors and if both kinds of errors meet or exceed the respective thresholds, (320, yes), the forecasting model may be too indecisive. In some implementations, if one error meets or exceeds its threshold but the other does not meet or exceed its threshold the model's error is not too high (320, No). In some implementations, the error threshold or thresholds may be provided as a parameter with the original request.

In some implementations, models with high error are disregarded and the system proceeds to analyze another anomaly candidate slice. In some implementations, the system may break up the number of dimensions in the slice, and try again. For example, if the anomaly candidate slice has five dimensions but the resulting trained model has high error (320, Yes), the system may issue a new request and use three of the five dimensions. Reducing the number of dimensions may result in candidates with more occurrences, which may result in a more reliable mode. However, such reprocessing is optional.

If the model is sufficiently decisive (320, No), the system may calculate an actual value from event index entries for the evaluation interval (325). In some implementations, this may be a query to the event repository for a recent time period covered by the evaluation duration. In some implementations, it may cover a most recent time period. In some implementations, the query that returns the data for the historical time series also returns the data points used to calculate the actual value. The actual value also represents an aggregate value, e.g., a count or average over the time period represented by the evaluation interval.

The system also obtains a forecast value from the forecast model (330). The system then compares the forecast value to the actual value to determine whether the actual value is within a predetermined range of the forecast value (335). If the actual value is outside of the predetermined range (335, No), the candidate slice is considered an anomaly slice and is provided to the requesting process (340). The predetermined range may be dependent upon a number of factors. One factor may be a maximum change, or max_delta. The maximum change can be a default value or can be provided as a parameter by the requesting process.

Another factor is a confidence interval calculated using a log accuracy ratio of the forecasting model. The log accuracy ratio may represented by |ln(holdoutᵥₐₗ)/(forecastᵥₐₗ)| for each evaluation interval in the holdout portion of the historical time-series. Holdoutᵥₐₗ is the value from an evaluation interval in the holdout portion of the historical time-series data and forecastᵥₐₗ is the predicted value for that interval from the forecasting model. In some implementations an extra weight may be added to avoid empty time buckets. In this case the log accuracy ratio may be represented as |ln(holdoutᵥₐₗ+extra_weight)/(forecastᵥₐₗ+extra_weight)|. The extra_weight may reflect the magnitude of the change considered an anomaly. In other words, the extra_weight parameter controls the sensitivity of the anomaly detection. For example, when a relatively small change may be seen as an anomaly, the system may use an extra_weight of one (1.0). When a small change is not seen as an anomaly, the system may use a larger extra_weight, e.g., of 100 or 1000. This log accuracy ratio may be calculated for each evaluation interval in the holdout data. This provides a distribution over the holdout data.

The log accuracy ratio distribution may be used to determine a confidence interval. The confidence interval is a range of values for which the forecasting model has a high percentage (e.g., 90%, 95% or 99%) of confidence that the actual value falls in. The system may use the upper bound of this confidence interval (ci_upper) to determine whether the actual value falls within a predetermined range, or in other words a variance, of the forecast value. In some implementations, the system may determine that the forecast value (forecastᵥₐₗ) is outside a predetermined range of the actual value (actualᵥₐₗ) when e\hat{ }ci_upper*forecastᵥₐₗ>actualᵥₐₗ*max_delta. In some implementations, the system may determine that the forecast value is outside a predetermined range of the actual value when actualᵥₐₗ<(e\hat{ }ci_upper*forecastᵥₐₗ)/max_delta. In some implementations, if either test is true, the system determines that the forecast value is outside the predetermined range of the actual value. In some implementations, the extra weight may be used to avoid empty time buckets, e.g., e\hat{ }ci_upper*(forecastᵥₐₗ+extra_weight)>(actualᵥₐₗ+extra_weight)*max_delta or (actualᵥₐₗ+extra_weight)<(e\hat{ }ci_upper*(forecastᵥₐₗ extra_weight))/max_delta.

The system repeats this process for each anomaly candidate slice. Because process 300 is only performed for a small subset of the possible slices in the event repository, it is possible to perform process 300 in real time for previously unspecified slices. In other words, the computationally expensive step of generating a forecasting model is only performed after a courser-grained candidate selection process that can be performed quickly. Process 300 could also be performed efficiently as a batch process and can be performed without the candidate selection process, i.e., all slices identified at step 225 of FIG. 2. In some implementations, process 300 is optional and other methods of evaluating the anomaly candidates may be used.

FIG. 4 illustrates an example event repository and FIG. 5 illustrates example requests, e.g., request 585(a) and request 585(b), and the candidate selection process for the requests. FIGS. 4 and 5 are provided for ease of discussion and illustration and are in no way limiting. In the example of FIG. 4, three leaf servers 414 are illustrated for the sake of brevity. The leaf servers 414 are similar to the leaf servers 114 of FIG. 1 and the root server 410 is similar to the root server 110 of FIG. 1. Each leaf server stores a shard of the event repository, e.g., indexed events 415. In this example three dimensions are recorded as part of possible event; pressure, temperature, and volume. In the example of FIG. 4, each event data pint 420 in the index 415 has a dimension label and an associated time (e.g., T1, T2, T3, etc.). A count of one (1) is assumed for each instance in the index.

In FIG. 5 a requesting process has provided three parameters as part of request 585(a); two dimensions and a test interval. Other parameters (not shown) may be provided with the request 585(a). The system may use the two dimensions to retrieve event data points 420 from the index 415 that match the dimensions of temperature and pressure. The system may obtain the events, e.g., event data points 420, that occur in a test interval of a one hour duration (e.g., T1) and eight reference durations (e.g., T2 to T9). For ease of illustration the time of the event data points 420 are shown in FIG. 4 as the interval to which they belong and not as a timestamp.

For example, for test interval T1, the root 410 receives a pressure dimension event with the label of 110 from leaf 414(1) and from 414(2). The root 410 also receives a temperature dimension event with the label of 37 for test interval T1. The root 410 (or another server) performs an n-way merge of the responses and calculates an aggregate value of two (2) for the combination of <temp=37, pressure=110> for test interval T1. The aggregate value represents a count of the occurrences of the slice <temp=37, pressure=110> in test interval T1. Similarly, the root. In a similar manner, for reference interval T3, the root 410 receives two dimension labels for the pressure dimension and two dimension labels for the temperature dimension. This means the n-way merge results in a cross-product of the dimension labels, each having an aggregate count of one (1).

In the example of FIG. 4, there is one pressure dimension event in interval T2, but no corresponding temperature dimension. Because no label exists for the temperature dimension there is not a valid slice for T2. This is considered an empty reference interval. As a result of the n-way merge for the remaining reference intervals, the slices 505-520 are generated. The system may select the top two slices. Slices 505 and 510 are selected because their overall occurrence is higher than slices 515 and 520. The system may compare the aggregate value of the test interval (T1) with the aggregate values of the reference intervals for each of the top 2 slices. For example, the system may consider slice 510 an anomaly candidate slice because it lacks an aggregate in the test interval T1. Slice 505 has an aggregate value in T1 but because this value is the same as the value in T7, slice 505 is not considered an anomaly candidate. Accordingly, only slice 510 is an anomaly candidate and is further evaluated (e.g., a forecast model generated and a forecasted value compared with an actual value from the event index 415). If the further analysis indicates that slice 510 represents an anomaly then the slice, i.e., <temp=17, pressure=17> is provided to the requesting process.

In the second example of FIG. 5, the requesting process only provides one dimension as a parameter. As a result of the n-way merge slices 550, 555, and 560 are provided. Selection of the top two slices results in slices 555 and 560 being considered for anomaly candidates. Only slice 560 is selected because it lacks a value for the test interval of T1. Thus, only slice 560 is an anomaly candidate slice and presented for further analysis, as described herein.

FIG. 6 shows an example of a generic computer device 600, which may be system 100 of FIG. 1, which may be used with the techniques described here. Computing device 600 is intended to represent various example forms of computing devices, such as laptops, desktops, workstations, personal digital assistants, cellular telephones, smart phones, tablets, servers, and other computing devices, including wearable devices. The components shown here, their connections and relationships, and their functions, are meant to be examples only, and are not meant to limit implementations of the inventions described and/or claimed in this document.

Computing device 600 includes a processor 602, memory 604, a storage device 606, and expansion ports 610 connected via an interface 608. In some implementations, computing device 600 may include transceiver 646, communication interface 644, and a GPS (Global Positioning System) receiver module 648, among other components, connected via interface 608. Device 600 may communicate wirelessly through communication interface 644, which may include digital signal processing circuitry where necessary. Each of the components 602, 604, 606, 608, 610, 640, 644, 646, and 648 may be mounted on a common motherboard or in other manners as appropriate.

The processor 602 can process instructions for execution within the computing device 600, including instructions stored in the memory 604 or on the storage device 606 to display graphical information for a GUI on an external input/output device, such as display 616. Display 616 may be a monitor or a flat touchscreen display. In some implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk. In some implementations, the memory 604 may include expansion memory provided through an expansion interface.

The storage device 606 is capable of providing mass storage for the computing device 600. In one implementation, the storage device 606 may be or include a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in such a computer-readable medium. The computer program product may also include instructions that, when executed, perform one or more methods, such as those described above. The computer- or machine-readable medium is a storage device such as the memory 604, the storage device 606, or memory on processor 602.

The interface 608 may be a high speed controller that manages bandwidth-intensive operations for the computing device 600 or a low speed controller that manages lower bandwidth-intensive operations, or a combination of such controllers. An external interface 640 may be provided so as to enable near area communication of device 600 with other devices. In some implementations, controller 608 may be coupled to storage device 606 and expansion port 614. The expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 630, or multiple times in a group of such servers. It may also be implemented as part of a rack server system. In addition, it may be implemented in a personal computer such as a laptop computer 622, or smart phone 636. An entire system may be made up of multiple computing devices 600 communicating with each other. Other configurations are possible.

FIG. 7 shows an example of a generic computer device 700, which may be system 100 of FIG. 1, which may be used with the techniques described here. Computing device 700 is intended to represent various example forms of large-scale data processing devices, such as servers, blade servers, datacenters, mainframes, and other large-scale computing devices. Computing device 700 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Distributed computing system 700 may include any number of computing devices 780. Computing devices 780 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 780a includes multiple racks 758a-758n. Each rack may include one or more processors, such as processors 752a-752n and 762a-762n. The processors may include data processors, network attached storage devices, and other computer controlled devices. In some implementations, one processor may operate as a master processor and control the scheduling and data distribution tasks. Processors may be interconnected through one or more rack switches 758, and one or more racks may be connected through switch 778. Switch 778 may handle communications between multiple connected computing devices 700.

Each rack may include memory, such as memory 754 and memory 764, and storage, such as 756 and 766. Storage 756 and 766 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 756 or 766 may be shared between multiple processors, multiple racks, or multiple computing devices and may include a computer-readable medium storing instructions executable by one or more of the processors. Memory 754 and 764 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 754 may also be shared between processors 752a-752n. Data structures, such as an index, may be stored, for example, across storage 756 and memory 754. Computing device 700 may include other components not shown, such as controllers, buses, input/output devices, communications modules, etc.

An entire system, such as system 100, may be made up of multiple computing devices 700 communicating with each other. For example, device 780a may communicate with devices 780b, 780c, and 780d, and these may collectively be known as system 100. As another example, system 100 of FIG. 1 may include one or more computing devices 700. Some of the computing devices may be located geographically close to each other, and others may be located geographically distant. The layout of system 700 is an example only and the system may take on other layouts or configurations.

According to one aspect, a method for identifying an anomalous event includes obtaining, from an event index that associates a timestamp with a dimension label and an aggregate value for the timestamp, a set of data points for events from the index that have a dimension matching a query dimension of one or more query dimensions and have a timestamp within a test interval or a reference interval of a plurality of reference intervals, wherein the one or more query dimensions define a dimension combination. The method also includes calculating, for each unique slice in each reference interval of the plurality of reference intervals and in the test interval, a respective aggregate value. A unique slice may be a combination of unique dimension label combinations from the set of data points that match the dimension combination of the query. The method also includes identifying anomaly candidate slices by, for at least some of the unique slices, determining that the unique slice appears in at least one reference interval but not in the test interval or the unique slice appears in all the reference intervals and in the test interval and a relative change between the aggregate value for the test interval and the respective aggregate value for any of the plurality of reference intervals meets a relative change threshold. The method also includes, for each anomaly candidate slice, generating a forecasting model from a historical time series obtained from the event index, the historical time series being index entries with dimension labels matching the dimension labels of the anomaly candidate slice, determining, using data from the event index, an actual value for an evaluation interval for the anomaly candidate slice, obtaining a forecast value for the anomaly candidate slice from the forecasting model, and responsive to determining that the forecast value is outside of a predetermined range of the actual value, reporting the anomaly candidate slice as an anomaly slice.

These and other aspects can include one or more of the following, alone or in combination. For example the at least some unique slices evaluated for anomaly candidates may be a predetermined number of slices with highest occurrence across the test interval and the plurality of reference intervals. As another example, the one or more query dimensions and the test interval may be obtained from a requesting process via an API and reporting the anomaly candidate slice as an anomaly slice may include reporting the dimension labels of the anomaly slice. As another example, for a reference interval where the relative change between the aggregate value for the test interval and the respective aggregate value for the reference interval meets a relative change threshold, identifying the unique slice as an anomaly candidate slice may occur responsive to also determining that an absolute change between the aggregate value for the test interval and the respective aggregate value for the reference interval meets an absolute change threshold. As another example, the aggregate value may be a count. In some implementations, the count is implied in the event index, each timestamp being a count of one for each dimension labels.

As another example, the test interval has test interval duration and each of the plurality of reference intervals has an associated duration that is a multiple of the test interval duration. In some implementations, for a reference interval with a duration that is longer than the test interval duration, an average of the aggregate value is calculated for each test interval duration in the duration of the reference interval. As another example, the forecasting model may be one of a linear regression model, a moving average model, or a locally estimated scatterplot smoothing (LOESS) model. As another example, the historical time series may include training data and holdout data, and generating the forecasting model may include using the holdout data to evaluate an accuracy of the forecasting model, and the predetermined range is dependent on the accuracy of the forecasting model. In some implementations, determining that the forecast value is outside of the predetermined range of the actual value can include computing an error over the holdout data using a log accuracy ratio and determining a confidence threshold c by determining a confidence interval from a distribution of the error over the holdout data. The predetermined range may be based on the confidence threshold c. In some implementations, determining that the forecast value is outside of a predetermined range of the holdout data includes obtaining a maximum difference threshold d, obtaining a forecast extra weight w, responsive to determining that c*(forecastᵥₐₗ+w)>(actualᵥₐₗ+w)*d, determining that the forecast value is outside of the predetermined range, where forecastᵥₐₗ is the forecast value and actualᵥₐₗ is the actual value, and responsive to determining that actualᵥₐₗ+w<(c*(forecastᵥₐₗ+w))/d, determining that the forecast value is outside of the predetermined range. As another example, obtaining index entries for an interval can include sending, by a root server to a plurality of leaf servers, a request that identifies the one or more query dimensions and the interval, searching, at each leaf server of the plurality of leaf servers, for event index entries that have a dimension matching a query dimension of the one or more query dimensions and that have a timestamp within the interval, and providing, by each leaf server of the plurality of leaf servers to the root server, responsive index entries, each responsive index entry including the label for the matching dimension, the timestamp, and the aggregate value.

According to one aspect, a method can include receiving at least one dimension, a test duration, a test start time, a reference start time, and a history duration from a requesting program, the test start time and the test duration defining a test interval, determining at least one reference interval based on the reference start time and the test duration, wherein each reference interval has a duration that is a multiple of the test duration, and obtaining, from an index of events, events that are responsive to the at least one dimension and have a timestamp within the test interval or within the at least one reference interval. The method may also include calculating, for each unique slice in each of the at least one reference interval and the test interval, a respective aggregate value, a unique slice being a unique dimension label combination from the responsive events, identifying anomaly candidate slices by, for each unique slice in at least some of the unique slices, comparing the aggregate value in the test interval with aggregate values in the at least one reference interval, and, for each anomaly candidate slice, building a forecasting model for the anomaly candidate slice based on events from the index of events that occur during the history duration, comparing a forecasted value obtained from the forecasting model with an actual value for the anomaly candidate slice, and reporting the anomaly candidate slice as an anomaly slice responsive to determining that the comparison indicates the actual value differs by at least a predetermined amount from the forecasted value outside of a confidence interval.

These and other aspects can include one or more of the following, alone or in combination. For example building the forecasting model for the anomaly candidate slice can include obtaining a historical time series from the index of events, the historical time series being events with dimension labels matching the dimension labels of the anomaly candidate slice and having a timestamp within the history duration and training a forecasting model using a first portion of the historical time series. In some implementations, building the forecasting model for the anomaly candidate slice includes determining the confidence interval based on a remaining portion of the historical time series. As another example, the predetermined amount may be received from the requesting program. As another example, the reference start time is a reference age and at least one reference period is also received from the requesting program and determining the at least one reference interval based on the reference start time and the test duration includes and determining a start time for the at least one reference interval by subtracting the reference age from the test start time. Calculating a respective aggregate value for the reference interval may include calculating, for each test duration in the at least one reference period, an interval aggregate value, and calculating the respective aggregate value as an average of the interval aggregate values. As another example, a reference period is received from the requesting program and calculating the respective aggregate value for the at least one reference interval can include calculating, for each test duration in the reference period, an interval aggregate value and calculating the respective aggregate value as an average of the interval aggregate values.

According to one aspect, a method includes receiving parameters from a requesting process, the parameters identifying at least one dimension for events captured in an event repository, a test start time and a test duration. The method may also include identifying, from the event repository, a set of events for the at least one dimension, the set including events occurring within a test interval defined by the test start time and the test duration and including events occurring within at least two reference intervals, the reference intervals occurring before the test interval and having a respective duration that is a multiple of the test duration. The method may also include generating, for each of the test interval and the at least two reference intervals, an aggregate value for each unique combination of dimension values in the set of events that occur in the interval, selecting at least one of the unique combination of dimension values for anomaly detection based on a comparison of the aggregate values for the reference intervals and the test interval, and performing anomaly detection on a historical time series for the selected unique combination of dimension values. The method may include reporting a result of the anomaly detection responsive to the anomaly detection indicating the selected unique combination of dimension values has an anomaly.

These and other aspects can include one or more of the following, alone or in combination. For example the parameters may identify two dimensions and generating the aggregate value for an interval can include including in the unique combination of dimension values a cross product of dimension values that exist for events in the set of events that occur during the interval for each of the two dimensions. In some implementations, the aggregate value is a count and each dimension value with a unique timestamp counts as an input to the cross product, and wherein each cross product gets a count of one. As another example, the method also includes selecting a predetermined number of unique combinations of dimension values for anomaly detection, wherein the unique combinations selected have highest occurrences within the set of events. As another example, performing anomaly detection may include training a forecasting model using the historical time series, obtaining a forecast value from the forecasting model, obtaining an actual value from the event repository for the selected unique combination of dimension values, and indicating that the selected unique combination of dimension values has an anomaly responsive to determining that the actual value exceeds a variance from the forecast value.

According to one aspect, a system includes at least one processor, a means for querying an event index for events occurring in a specified interval for specified dimensions, a means for generating unique combinations of dimension labels for the events occurring in the specified interval, a means for determining whether any of the unique slices are an anomaly candidate, and a means for evaluating the anomaly candidates using a forecasting model.

According to one aspect, a system includes at least one processor and memory storing instructions that, when executed by the at least one processor, cause the system to perform any of the methods disclosed herein.

The aspects and optional features of each aspect may be combined in any suitable way. For example, optionally embodiments of one aspect may be used in other aspects.

In addition to the implementations described above, the following implementations are also innovative:

Embodiment 1 is a method comprising obtaining, from an event index that associates a timestamp with a dimension label and an aggregate value for the timestamp, a set of data points for events from the index that have a dimension matching a query dimension of one or more query dimensions and have a timestamp within a test interval or a reference interval of a plurality of reference intervals, wherein the one or more query dimensions define a dimension combination. The method also includes calculating, for each unique slice in each reference interval of the plurality of reference intervals and in the test interval, a respective aggregate value. A unique slice may be a combination of unique dimension label combinations from the set of data points that match the dimension combination of the query. The method also includes identifying anomaly candidate slices by, for at least some of the unique slices, determining that the unique slice appears in at least one reference interval but not in the test interval or the unique slice appears in all the reference intervals and in the test interval and a relative change between the aggregate value for the test interval and the respective aggregate value for any of the plurality of reference intervals meets a relative change threshold. The method also includes, for each anomaly candidate slice, generating a forecasting model from a historical time series obtained from the event index, the historical time series being index entries with dimension labels matching the dimension labels of the anomaly candidate slice, determining, using data from the event index, an actual value for an evaluation interval for the anomaly candidate slice, obtaining a forecast value for the anomaly candidate slice from the forecasting model, and responsive to determining that the forecast value is outside of a predetermined range of the actual value, reporting the anomaly candidate slice as an anomaly slice.

Embodiment 2 is the method of embodiment 1, wherein the at least some unique slices evaluated for anomaly candidates are a predetermined number of slices with highest occurrence across the test interval and the plurality of reference intervals.

Embodiment 3 is method of any one of embodiments 1-2, wherein the one or more query dimensions and the test interval are obtained from a requesting process via an API and reporting the anomaly candidate slice as an anomaly slice includes reporting the dimension labels of the anomaly slice.

Embodiment 4 is the method of embodiments 1, 2, or 3, wherein for a reference interval where the relative change between the aggregate value for the test interval and the respective aggregate value for the reference interval meets a relative change threshold, identifying the unique slice as an anomaly candidate slice occurs responsive to also determining that an absolute change between the aggregate value for the test interval and the respective aggregate value for the reference interval meets an absolute change threshold.

Embodiment 5 is the method of any one of embodiments 1-4, wherein the aggregate value is a count.

Embodiment 6 is the method of embodiment 5, wherein the count is implied in the event index, each timestamp being a count of one for each dimension labels.

Embodiment 7 is the method of any one of embodiments 1-5, wherein the test interval has test interval duration and each of the plurality of reference intervals has an associated duration that is a multiple of the test interval duration.

Embodiment 8 is the method of embodiment 7, wherein for a reference interval with a duration that is longer than the test interval duration, an average of the aggregate value is calculated for each test interval duration in the duration of the reference interval.

Embodiment 9 is the method of any one of embodiments 1-7 wherein the forecasting model is one of a linear regression model, a moving average model, or a locally estimated scatterplot smoothing (LOESS) model.

Embodiment 10 is the method of any one of embodiments 1-8, wherein the historical time series includes training data and holdout data, and generating the forecasting model includes using the holdout data to evaluate an accuracy of the forecasting model, and the predetermined range is dependent on the accuracy of the forecasting model.

Embodiment 11 is the method of embodiment 10, wherein determining that the forecast value is outside of the predetermined range of the actual value includes: computing an error over the holdout data using a log accuracy ratio, and determining a confidence threshold c by determining a confidence interval from a distribution of the error over the holdout data, wherein the predetermined range is based on the confidence threshold c.

Embodiment 12 is the method of embodiment 11, wherein determining that the forecast value is outside of a predetermined range of the holdout data includes: obtaining a maximum difference threshold d; obtaining a forecast extra weight w; responsive to determining that c*(forecastᵥₐₗ>(actualᵥₐₗ+w)*d, determining that the forecast value is outside of the predetermined range, where forecastᵥₐₗ is the forecast value and actualᵥₐₗ is the actual value, and responsive to determining that actualᵥₐₗ+w<(c (forecastᵥₐₗ+w))/d, determining that the forecast value is outside of the predetermined range.

Embodiment 13 is the method of any one of embodiments 1-12, wherein obtaining index entries for an interval includes: sending, by a root server to a plurality of leaf servers, a request that identifies the one or more query dimensions and the interval, searching, at each leaf server of the plurality of leaf servers, for event index entries that have a dimension matching a query dimension of the one or more query dimensions and that have a timestamp within the interval, and providing, by each leaf server of the plurality of leaf servers to the root server, responsive index entries, each responsive index entry including the label for the matching dimension, the timestamp, and the aggregate value.

Embodiment 14 is a method comprising: receiving parameters from a requesting process, the parameters identifying at least one dimension for events captured in an event repository, a test start time and a test duration; identifying, from the event repository, a set of events for the at least one dimension, the set including events occurring within a test interval defined by the test start time and the test duration and including events occurring within at least two reference intervals, the reference intervals occurring before the test interval and having a respective duration that is a multiple of the test duration; generating, for each of the test interval and the at least two reference intervals, an aggregate value for each unique combination of dimension values in the set of events that occur in the interval; based on a comparison of the aggregate values for the reference intervals and the test interval, selecting at least one of the unique combination of dimension values for anomaly detection; and performing anomaly detection on a historical time series for the selected unique combination of dimension values; and reporting a result of the anomaly detection responsive to the anomaly detection indicating the selected unique combination of dimension values has an anomaly.

Embodiment 15 is the method of embodiment 14, wherein the parameters identify two dimensions and generating the aggregate value for an interval includes: including in the unique combination of dimension values a cross product of dimension values that exist for events in the set of events that occur during the interval for each of the two dimensions.

Embodiment 16 is the method of embodiment 15, wherein the aggregate value is a count and each dimension value with a unique timestamp counts as an input to the cross product, and wherein each cross product gets a count of one.

Embodiment 17 is the method of embodiment 14, 15, or 16, further comprising: selecting a predetermined number of unique combinations of dimension values for anomaly detection, wherein the unique combinations selected have highest occurrences within the set of events.

Embodiment 18 is the method of any one of embodiments 12-17, wherein performing anomaly detection includes: training a forecasting model using the historical time series; obtaining a forecast value from the forecasting model; obtaining an actual value from the event repository for the selected unique combination of dimension values; and indicating that the selected unique combination of dimension values has an anomaly responsive to determining that the actual value exceeds a variance from the forecast value.

Various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any non-transitory computer program product, apparatus and/or device (e.g., magnetic discs, optical disks, memory (including Read Access Memory), Programmable Logic Devices (PLDs)) used to provide machine instructions and/or data to a programmable processor.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, various modifications may be made without departing from the spirit and scope of the disclosure. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method for identifying an anomalous event, the method comprising:
obtaining, from an event index that associates a timestamp with a dimension label and an aggregate value for the timestamp, a set of data points for events from the event index that have a dimension matching a query dimension of one or more query dimensions and have a timestamp within a test interval or a reference interval of a plurality of reference intervals, wherein the one or more query dimensions define a dimension combination;
calculating, for each unique slice in each reference interval of the plurality of reference intervals and in the test interval, a respective aggregate value, a unique slice being a combination of unique dimension label combinations from the set of data points that match the dimension combination of the query;
identifying anomaly candidate slices by, for at least some of the unique slices, determining that:
the unique slice appears in at least one reference interval but not in the test interval, or
the unique slice appears in all the reference intervals and in the test interval and a relative change between the aggregate value for the test interval and the respective aggregate value for any of the plurality of reference intervals meets a relative change threshold; and
for each anomaly candidate slice:
generating a forecasting model from a historical time series obtained from the event index, the historical time series being index entries with dimension labels matching the dimension labels of the anomaly candidate slice,
determining, using data from the event index, an actual value for an evaluation interval for the anomaly candidate slice,
obtaining a forecast value for the anomaly candidate slice from the forecasting model, and
responsive to determining that the forecast value is outside of a predetermined range of the actual value, reporting the anomaly candidate slice as an anomaly slice.

2. The method of claim 1, wherein the at least some unique slices evaluated for anomaly candidates are a predetermined number of slices with highest occurrence across the test interval and the plurality of reference intervals.

3. The method of claim 1, wherein the one or more query dimensions and the test interval are obtained from a requesting process via an API and reporting the anomaly candidate slice as an anomaly slice includes reporting the dimension labels of the anomaly slice.

4. The method of claim 1, wherein for a reference interval where the relative change between the aggregate value for the test interval and the respective aggregate value for the reference interval meets the relative change threshold, identifying the unique slice as an anomaly candidate slice occurs responsive to also determining that an absolute change between the aggregate value for the test interval and the respective aggregate value for the reference interval meets an absolute change threshold.

5. The method of claim 1, wherein the aggregate value is a count.

6. The method of claim 5, wherein the count is implied in the event index, each timestamp being a count of one for each dimension labels.

7. The method of claim 1, wherein the test interval has test interval duration and each of the plurality of reference intervals has an associated duration that is a multiple of the test interval duration.

8. The method of claim 7, wherein for a reference interval with a duration that is longer than the test interval duration, an average of the aggregate value is calculated for each test interval duration in the duration of the reference interval.

9. The method of claim 1, wherein the forecasting model is one of a linear regression model, a moving average model, or a locally estimated scatterplot smoothing (LOESS) model.

10. The method of claim 1, wherein the historical time series includes training data and holdout data, and generating the forecasting model includes using the holdout data to evaluate an accuracy of the forecasting model, and the predetermined range is dependent on the accuracy of the forecasting model.

11. The method of claim 10, wherein determining that the forecast value is outside of the predetermined range of the actual value includes:
computing an error over the holdout data using a log accuracy ratio; and
determining a confidence threshold c by determining a confidence interval from a distribution of the error over the holdout data,
wherein the predetermined range is based on the confidence threshold c.

12. The method of claim 11, wherein determining that the forecast value is outside of a predetermined range of the holdout data includes:
obtaining a maximum difference threshold d;
obtaining a forecast extra weight w;
responsive to determining that c*(f orecastᵥₐₗ+w)>(actualᵥₐₗ+w)*d, determining that the forecast value is outside of the predetermined range, where forecastᵥₐₗ is the forecast value and actualᵥₐₗ is the actual value, and
responsive to determining that actualᵥₐₗ+w<(c*(forecastᵥₐₗ+w))/d, determining that the forecast value is outside of the predetermined range.

13. The method of claim 1, wherein obtaining index entries for an interval includes:
sending, by a root server to a plurality of leaf servers, a request that identifies the one or more query dimensions and the interval,
searching, at each leaf server of the plurality of leaf servers, for event index entries that have a dimension matching a query dimension of the one or more query dimensions and that have a timestamp within the interval, and
providing, by each leaf server of the plurality of leaf servers to the root server, responsive index entries, each responsive index entry including the label for the matching dimension, the timestamp, and the aggregate value.

14. A method comprising:
receiving at least one dimension, a test duration, a test start time, a reference start time, and a history duration from a requesting program, the test start time and the test duration defining a test interval;
determining at least one reference interval based on the reference start time and the test duration, wherein each reference interval has a duration that is a multiple of the test duration;
obtaining, from an index of events, events that are responsive to the at least one dimension and have a timestamp within the test interval or within the at least one reference interval;
calculating, for each unique slice in each of the at least one reference interval and the test interval, a respective aggregate value, a unique slice being a unique dimension label combination from the responsive events;
identifying anomaly candidate slices by, for each unique slice in at least some of the unique slices, comparing the aggregate value in the test interval with aggregate values in the at least one reference interval; and
for each anomaly candidate slice:
building a forecasting model for the anomaly candidate slice based on events from the index of events that occur during the history duration,
comparing a forecasted value obtained from the forecasting model with an actual value for the anomaly candidate slice, and
reporting the anomaly candidate slice as an anomaly slice responsive to determining that the comparison indicates the actual value differs by at least a predetermined amount from the forecasted value outside of a confidence interval.

15. The method of claim 14, wherein building the forecasting model for the anomaly candidate slice includes:
obtaining a historical time series from the index of events, the historical time series being events with dimension labels matching the dimension labels of the anomaly candidate slice and having a timestamp within the history duration; and
training the forecasting model using a first portion of the historical time series.

16. The method of claim 15, building the forecasting model for the anomaly candidate slice includes:
determining the confidence interval based on a remaining portion of the historical time series.

17. The method of claim 14, wherein the predetermined amount is received from the requesting program.

18. The method of claim 14, wherein the reference start time is a reference age and at least one reference period is also received from the requesting program and determining the at least one reference interval based on the reference start time and the test duration includes:
determining a start time for the at least one reference interval by subtracting the reference age from the test start time,
wherein calculating a respective aggregate value for the reference interval includes:
calculating, for each test duration in the at least one reference period, an interval aggregate value, and
calculating the respective aggregate value as an average of the interval aggregate values.

19. The method of claim 14, wherein a reference period is received from the requesting program and calculating the respective aggregate value for the at least one reference interval includes:
calculating, for each test duration in the reference period, an interval aggregate value, and
calculating the respective aggregate value as an average of the interval aggregate values.

20. A method comprising:
receiving parameters from a requesting process, the parameters identifying at least one dimension for events captured in an event repository, a test start time and a test duration;
identifying, from the event repository, a set of events for the at least one dimension, the set including events occurring within a test interval defined by the test start time and the test duration and including events occurring within at least two reference intervals, the reference intervals occurring before the test interval and having a respective duration that is a multiple of the test duration;
generating, for each of the test interval and the at least two reference intervals, an aggregate value for each unique combination of dimension values in the set of events that occur in the interval;
based on a comparison of the aggregate values for the reference intervals and the test interval, selecting at least one of the unique combination of dimension values for anomaly detection;
performing the anomaly detection on a historical time series for the selected unique combination of dimension values; and
reporting a result of the anomaly detection responsive to the anomaly detection indicating the selected unique combination of dimension values has an anomaly.

21. The method of claim 20, wherein the parameters identify two dimensions and generating the aggregate value for an interval includes:
including in the unique combination of dimension values a cross product of dimension values that exist for events in the set of events that occur during the interval for each of the two dimensions.

22. The method of claim 21, wherein the aggregate value is a count and each dimension value with a unique timestamp counts as an input to the cross product, and wherein each cross product gets a count of one.

23. The method of claim 20, further comprising:
selecting a predetermined number of unique combinations of dimension values for anomaly detection, wherein the unique combinations selected have highest occurrences within the set of events.

24. The method of claim 20, wherein
performing the anomaly detection includes:
training a forecasting model using the historical time series;
obtaining a forecast value from the forecasting model;
obtaining an actual value from the event repository for the selected unique combination of dimension values; and
indicating that the selected unique combination of dimension values has an anomaly responsive to determining that the actual value exceeds a variance from the forecast value.

25. (canceled)
